(19) United States
(12) Patent Application Publication
(10) Pub. No.: US 2019/0063413 A1
(43) Pub. Date: Feb. 28, 2019

(54) BARREL CAM DRIVEN RECIPROCATING PUMP

(71) Applicant: KONINKLIJKE PHILIPS N.V., Eindhoven (NL)

(72) Inventor: DANIEL PAUL SERVANSKY, CANTON, GA (US)

(21) Appl. No.: 16/106,822

(22) Filed: Aug. 21, 2018

Related U.S. Application Data
(60) Provisional application No. 62/549,010, filed on Aug. 23, 2017.

(51) Int. Cl. F04B 9/04; F04B 27/10; F04B 35/04; F04B 37/12

(52) U.S. Cl. CPC F04B 9/042; F04B 27/1054; F05B 2260/506; F04B 37/12; F04B 35/04

(57) ABSTRACT

A system for pumping and/or compressing fluids is provided. The system comprises a base, a motor, a cam configured to be rotated about an axis of rotation by the motor, and one or more cylinder piston arrangements. Each cylinder piston arrangement comprises a first member and a second member. The first member has a longitudinal axis and two ends. The first member is fixedly attached to the base. The second member is configured to be operatively coupled to the cam and to be movable along the longitudinal axis with respect to the first member and through at least of the two ends. The axis of rotation of the cam is parallel to the longitudinal axis about which the second member moves relative to the first member.

### CROSS-REFERENCE TO RELATED APPLICATIONS

This patent application claims the priority benefit under 35 U.S.C. § 119(e) of U.S. Provisional Application No. 62/549,010 filed on Aug. 23, 2017, the contents of which are herein incorporated by reference.

### BACKGROUND OF THE INVENTION

### 1. Field of the Invention

The present patent application pertains to a system and a method for pumping and/or compressing fluids.

### 2. Description of the Related Art

Pumps and compressors are generally used in industrial, commercial, healthcare, consumer goods and medical device applications. These pumps and compressors typically fall into rotary and reciprocating piston type categories with the most common being reciprocating piston type pumps and compressors. Generally, rotary pumps and compressors are used in industrial (e.g., gas separation, oil, etc.) and aviation applications. Reciprocating pumps and compressors are generally used for commercial, healthcare, consumer goods and medical device applications. For example, the compressors commonly used in oxygen concentrators are wobble piston type reciprocating compressors where two pistons are located on opposite sides of a motor and are driven by eccentrics.

Several patents exist that disclose the derivation of reciprocating motion from rotary motion using cams and followers, and more specifically these patents disclose using cam and follower mechanism to drive pistons in a reciprocating motion. Some examples of these patents include U.S. Pat. No. 3,258,992, U.S. Pat. No. 3,402,668, and U.S. Pat. No. 4,459,945. Additionally, there are also prior art patents that disclose using a pin in a linear cam with a track to lift an object, for example, U.S. Pat. No. 3,655,070.

### SUMMARY

Accordingly, it is an object of one or more embodiments of the present patent application to provide a system for pumping and/or compressing fluids. The system comprises a base, a motor, a cam configured to be rotated about an axis of rotation by the motor, and one or more cylinder piston arrangements. Each cylinder piston arrangement comprises a first member and a second member. The first member has a longitudinal axis and two ends. The first member is fixedly attached to the base. The second member is configured to be operatively coupled to the cam and to be movable along the longitudinal axis with respect to the first member and through at least of the two ends. The axis of rotation of the cam is parallel to the longitudinal axis about which the second member moves relative to the first member.

It is yet another aspect of one or more embodiments of the present patent application to provide a method for pumping and/or compressing fluids using a motor and one or more cylinder piston arrangements. Each cylinder piston arrangement includes a first member and a second member. The first member has a longitudinal axis and two ends and is fixedly attached to a base. The second member configured to be operatively coupled to a cam. The method comprises rotating the cam about an axis of rotation by the motor, and reciprocating the second member of each cylinder piston arrangement along the longitudinal axis with respect to the corresponding first member and through the two ends of the corresponding first member to pump and/or compress the fluids. The axis of rotation of the cam is parallel to the longitudinal axis about which the second member moves relative to the corresponding first member.

It is yet another aspect of one or more embodiments to provide a system for pumping and/or compressing fluids using a motor and one or more cylinder piston arrangements. Each cylinder piston arrangement comprises a first member and a second member. The first member has a longitudinal axis and two ends and is fixedly attached to a base. The system comprises means for operatively coupling the second member to the motor. The means is rotated about an axis of rotation by the motor and the means is configured for reciprocating the second member of each cylinder piston arrangement along the longitudinal axis with respect to the corresponding first member and through the two ends of the corresponding first member to pump and/or compress the fluids. The axis of rotation of the means is parallel to the longitudinal axis about which the second member moves relative to the corresponding first member.

These and other objects, features, and characteristics of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present patent application.

### BRIEF DESCRIPTION OF THE DRAWINGS

FIGS. 1-3 show different perspective views of a system for pumping and/or compressing fluids in accordance with an embodiment of the present patent application;

FIG. 4 shows a top plan view of the system for pumping and/or compressing fluids in accordance with an embodiment of the present patent application;

FIG. 5 shows a top perspective view of the system for pumping and/or compressing fluids in accordance with an embodiment of the present patent application;

FIG. 6 shows a top cross-sectional view of the system for pumping and/or compressing fluids in accordance with an embodiment of the present patent application;

FIG. 7 shows a left side view of the system for pumping and/or compressing fluids in accordance with an embodiment of the present patent application;

FIG. 8 shows a right side view of the system for pumping and/or compressing fluids in accordance with an embodiment of the present patent application;

FIG. 9 shows a top plan view of a barrel cam of the system for pumping and/or compressing fluids in accordance with an embodiment of the present patent application;

FIG. 10 shows a front view of the barrel cam of the system for pumping and/or compressing fluids in accordance with an embodiment of the present patent application;

FIG. 11 shows a side view of the barrel cam of the system for pumping and/or compressing fluids in accordance with an embodiment of the present patent application;

FIG. 12 shows a partial perspective view of the system for pumping and/or compressing fluids in accordance with an embodiment of the present patent application, where some portions of the system are not shown for sake of clarity and to better illustrate other components of the system;

FIGS. 13, 14 and 15 show partial cross-sectional views of the system for pumping and/or compressing fluids in accordance with an embodiment of the present patent application, where at least a piston of the system is shown at a bottom stroke, a middle stroke and a top stroke in FIGS. 13, 14 and 15, respectively;

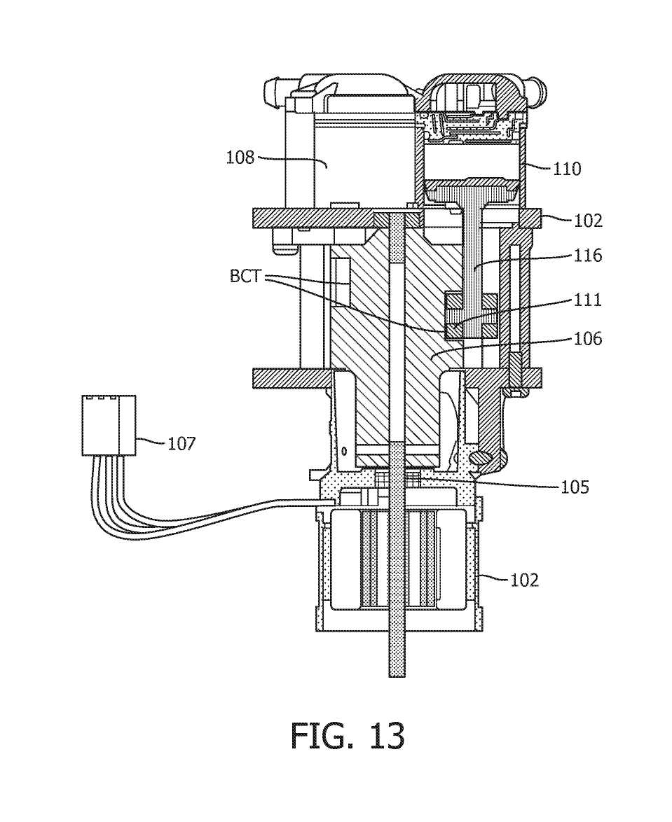

FIG. 16 shows a graphical illustration depicting a comparison of stroke profiles between a prior art eccentric driven pump/compressor and the system for pumping and/or compressing fluids in accordance with an embodiment of the present patent application;

FIGS. 17 and 18 show two prior art compressor arrangements;

FIG. 19 shows another view of the system for pumping and/or compressing fluids in accordance with an embodiment of the present patent application;

FIGS. 20a-20d show views of single cylinder, two-cylinder, three-cylinder, and four-cylinder arrangements of the prior art pump/compressor arrangements;

FIGS. 21a-21d show top views of single cylinder, two-cylinder, three-cylinder, and four-cylinder arrangements of the system for pumping and/or compressing fluids in accordance with an embodiment of the present patent application; and

FIG. 22 shows a graphical illustration depicting a comparison of occupied volume by cylinder count between a prior art eccentric driven pump/compressor and the system for pumping and/or compressing fluids in accordance with an embodiment of the present patent application; and

FIG. 23 shows a method for pumping and/or compressing fluids in accordance with an embodiment of the present patent application.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other. As used herein, the term “or” means “and/or” unless the context clearly dictates otherwise.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

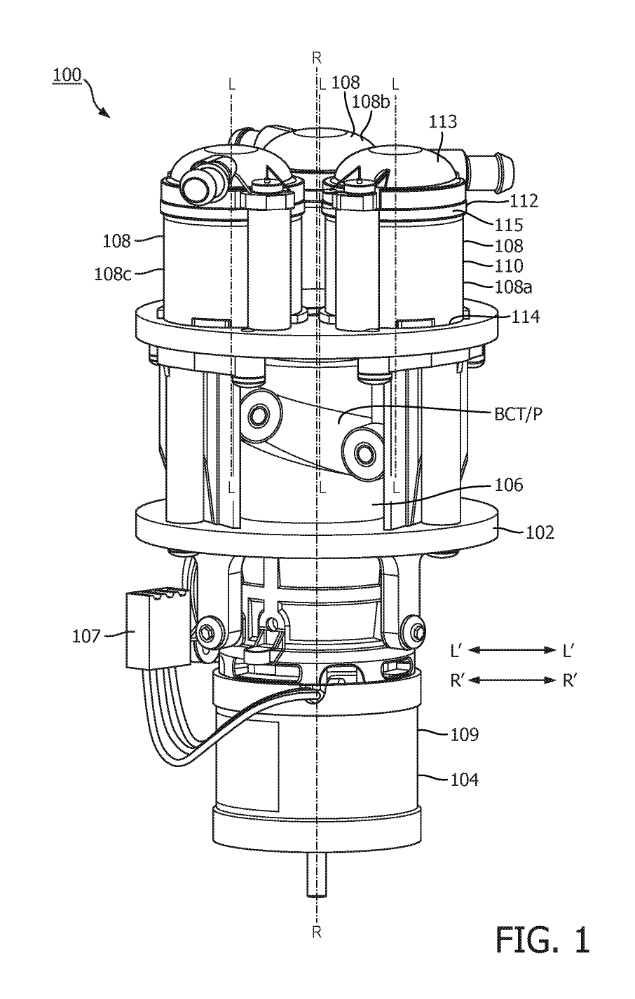

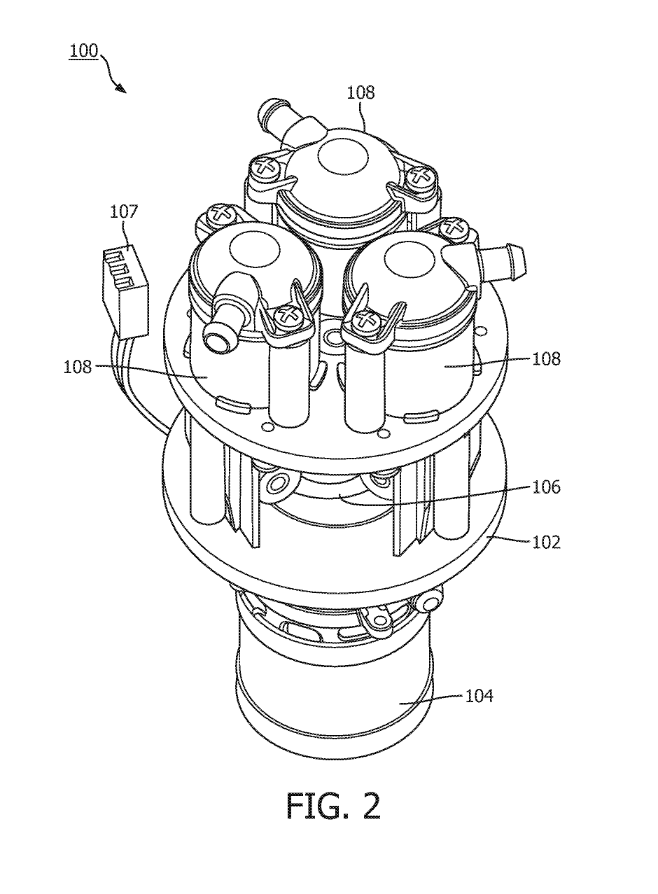

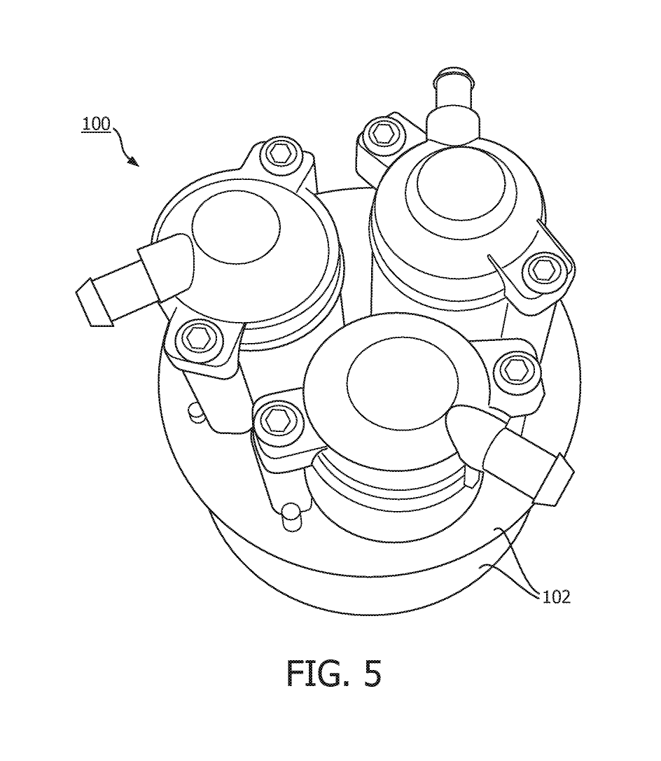

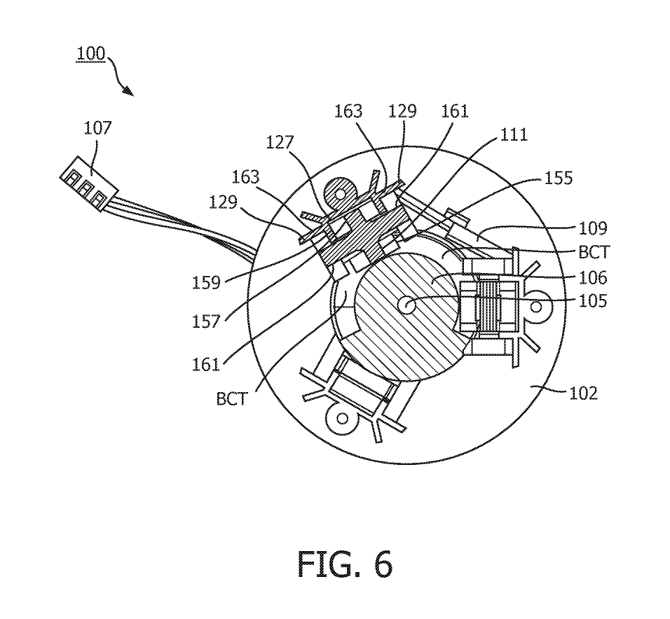

In one embodiment, referring to FIGS. 1-8, the present patent application provides a system 100 for pumping and/or compressing fluids. System 100 comprises a base 102, a motor 104, a cam 106 configured to be rotated about an axis of rotation R-R by motor 104, and one or more cylinder piston arrangements 108. In one embodiment, each cylinder piston arrangement 108 includes a first member 110 having a longitudinal axis L-L and two ends 112, 114. In one embodiment, each cylinder piston arrangement 108 also includes a second member 116 configured to be operatively coupled to cam 106 and to be movable along longitudinal axis L-L with respect to the first member 110 and through two ends 112, 114 of first member 110. In one embodiment, first member 110 is fixedly attached to base 102. In one embodiment, axis of rotation R-R of cam 106 is parallel to longitudinal axis L-L about which second member 116 moves relative to first member 110.

In one embodiment, system 100 is configured for pumping fluids for the purpose of moving fluids from one location to another location. In one embodiment, system 100 is configured for drawing a vacuum. In one embodiment, system 100 is configured for delivering gases at high pressure or for compressing gases.

In one embodiment, system 100 is configured for pumping and/or compressing fluids through one or more reciprocating pistons or diaphragms. In one embodiment, the one or more reciprocating pistons are configured to be positioned around cam 106 and controlled by cam 106 (i.e., a barrel or a cylindrical cam). In illustrative embodiment of FIGS. 1-8, system 100 includes a compressor having three pistons and three cylinders that are arranged uniformly around and driven in a linear reciprocating motion by barrel cam 106. For example, FIGS. 1-8 show a working prototype of a three-cylinder version of this mechanism using component from a compressor of an oxygen concentrator. As will be clear from the discussions below, the number of cylinder piston arrangements in system 100 may vary.

System 100 of the present patent application is significantly different from and is an improvement upon the prior art patents that are discussed in the “Description of the Related Art” section above due to the barrel cam arrangement.

Where the pump mechanisms described in the prior art patents utilize cams and followers they are of the radial type cam and follower mechanism. By contrast, system 100 described in the present patent application utilizes cam 106 of the cylindrical type. In a radial type cam and follower mechanism that is described in the prior art patents, a spring is typically required to maintain contact between the cam and the follower. Also, the axis of rotation of the cam and the axis of reciprocation of the follower are perpendicular to each other in the prior art radial type cam and follower mechanism. System 100 of the present patent application differs from the prior art radial type cam and follower mechanism in that cylindrical/barrel cam 106 does not require a spring to maintain contact between cam 106 and a follower 111 and axis of rotation R-R of cam 106 and axis of reciprocation L-L are parallel to each other which allows for a more compact mechanism in system 100.

System 100 also differs from a linear cam mechanism disclosed in the prior art patents because the prior art linear cam mechanism requires the cam to reverse its direction of travel to go from a lifting state to a lowering state. By contrast, cylindrical cam 106 of the present patent application has continuous track BCT that allows cam 106 to continue rotating in the same direction while switching between a lifting state and a lowering state. This arrangement is described in great detail below with reference to the drawings of the present patent application.

In one embodiment, first member 110 is a cylinder. In one embodiment, second member 116 is a piston. In one embodiment, piston 116 may be replaced with diaphragm.

In one embodiment, base 102 may be compressor or pump housing or a part/portion thereof In one embodiment, compressor/piston housing or base 102 is generally stationary (or non-moveable). In one embodiment, first member/cylinder 110 of the cylinder piston arrangement 108 is fixedly attached to base 102 so as to remain stationary with respect to second member/piston 116 of the cylinder piston arrangement 108.

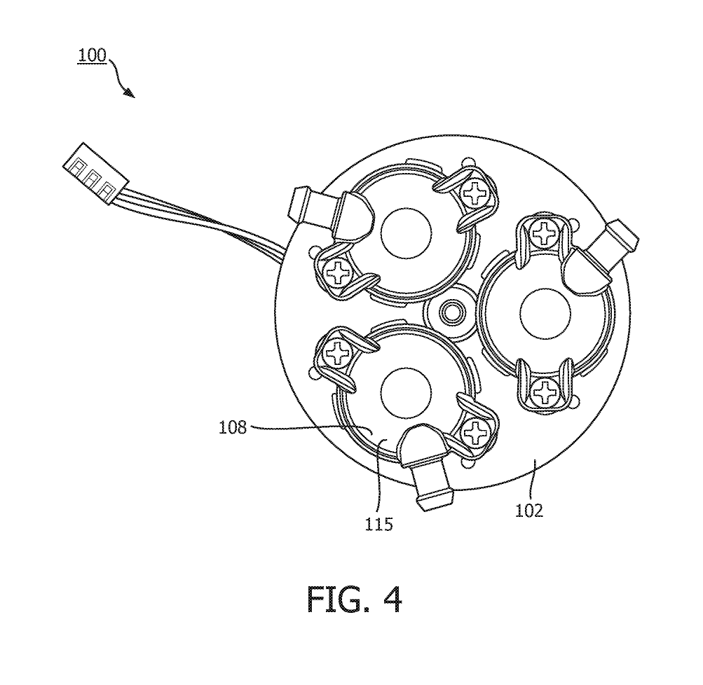

In one embodiment, as will be described in detail below with respect to FIG. 6, compressor/piston housing or base 102 further includes features 129 that interface with second member/piston 116 of the cylinder piston arrangement 108 to limit any rotation of piston 116. In one embodiment, as shown in FIG. 6, these features may include a linear rail 129.

In one embodiment, as will be described in detail below with respect to FIG. 6, compressor/piston housing or base 102 also includes features 127 that interfaces with second member/piston 116 to limit the reciprocating motion of piston 116 to be linear in nature. In one embodiment, as shown in FIG. 6, these features may include a linear track 127.

In one embodiment, motor 104 is configured for providing motive force to cylinder piston arrangements 108 via cam 106. In one embodiment, referring to FIG. 6, motor 104 includes a motor drive shaft 105, motor wires 107 and a motor housing 109. In one embodiment, motor drive shaft 105 is operatively coupled to cam 106 so as to rotate cam 106 about axis of rotation R-R. In one embodiment, motor 104 is an electrically powered motor. In one embodiment, electrical power may be supplied to motor 104 via motor wires 107. In one embodiment, rotation of barrel cam 106 is generated by motor 104.

When the power is supplied to motor 104, motor 104 and its drive shaft 105 rotate about axis of rotation R-R. Cam 106 that is operatively coupled to motor drive shaft 105 and is also rotated, about axis of rotation R-R, by motor drive shaft 105. in one embodiment, cam 106 may be operatively connected to the motor drive shaft 105 in any suitable manner such as being mounted to motor drive shaft 105 by motor drive shaft 105 extending into and being operatively coupled/connected to a portion of cam 106.

In one embodiment, as shown in FIG. 1, each cylinder piston arrangement 108 also includes a cylinder head 113 and a valve 115. In one embodiment, cylinder 110 of cylinder piston arrangement 108 is attached to compressor/piston housing or base 102 so that cylinder 110 of cylinder piston arrangement 108 remains stationary as the associated piston reciprocates therein. In one embodiment, the structure, configuration and operation of cylinder 110, cylinder head 113, and valve 115 are generally known to one skilled in the art and hence will be described in detail here.

In one embodiment, piston 116 is linearly moveable or reciprocatable within its respective cylinder 110 through an intake stroke and a compression stroke during a single rotation of cam 106. In one embodiment, piston 116 may not be limited to linear reciprocating motion and instead may follow a defined path during its reciprocation. In one embodiment, motion or movement of piston 116 within its respective cylinder 110 for pumping and/or compressing fluids generally known to one skilled in the art and hence will be described in detail here.

In one embodiment, piston 116 of each cylinder piston arrangement 108 is configured to reciprocate through a following mechanism (i.e., follower 111) that interfaces with track BCT of barrel cam 106 and reciprocate in a motion parallel to the axis of rotation R-R of barrel cam 106.

In the illustrative embodiments of FIGS. 1-8, system 100 includes three cylinder piston arrangements 108. In one embodiment, the number of cylinder piston arrangements may vary. That is, system 100 may include fewer than three cylinder piston arrangements or greater than three cylinder piston arrangements.

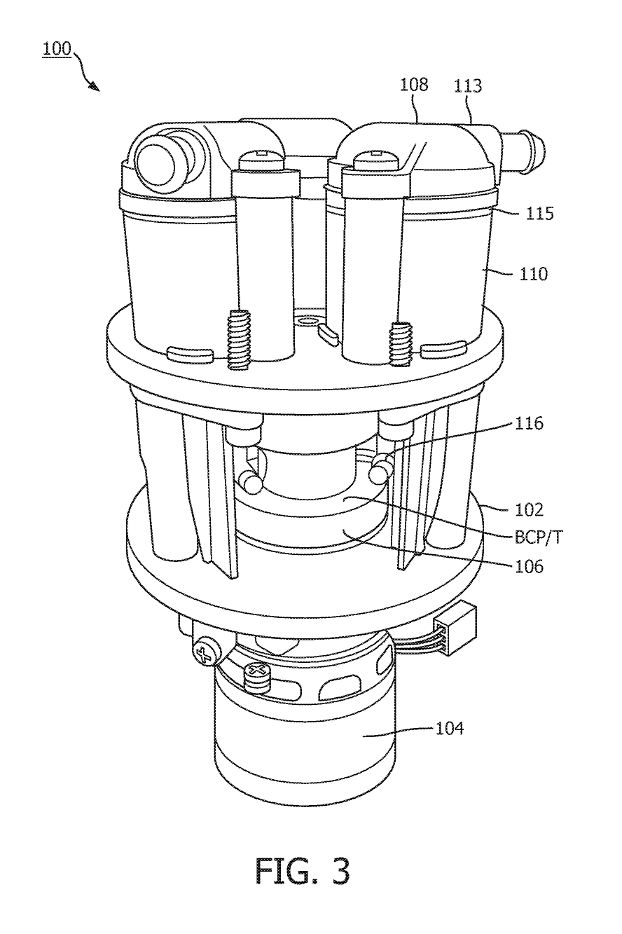

In one embodiment, as shown by a dotted line in FIG. 5, cylinder piston arrangements 108 are generally arranged around barrel cam 106. In one embodiment, cylinder piston arrangements 108 are in a reciprocating motion by barrel cam 106. In one embodiment, system 100 with cylinder piston arrangements 108 is a reciprocating compressor/pump system. In one embodiment, the reciprocating compressor/pump system is a positive-displacement compressor/pump system that uses pistons in a reciprocating motion to either move liquids or deliver gases at high pressure. In one embodiment, reciprocating motion or movement generally refers to a repetitive up and down linear motion or a back and forth linear motion. In one embodiment, reciprocating motion may also generally be referred to as a linear moveable motion.

In the illustrative embodiments of the present patent application, the reciprocating motion of piston 116 is shown and described as being repetitive up and down motion (i.e., parallel to the L-L axis of FIG. 1) and the axis of rotation of motor 104 and cam 106 being the axis, R-R, which is also parallel to axis L-L. In another embodiment, the reciprocating motion of piston 116 may be repetitive back and forth linear motion along an axis L′-L′ (i.e., perpendicular to the L-L axis of FIG. 1). In such an embodiment, the axis of rotation of motor 104 is an axis R′-R′, which is parallel to the axis of L′-L′.

In one embodiment, cylinder piston arrangements 108 of system 100 are uniformly spaced around barrel cam 106. For example, in one embodiment, a three-cylinder system may have 120 degrees of separation between each of its cylinder piston arrangements.

In another embodiment, cylinder piston arrangements 108 of system 100 are not uniformly spaced around barrel cam 106. For example, in one embodiment, a three-cylinder system may have 60 degrees of separation between cylinder piston arrangements 1 and 2, 180 degrees of separation between cylinder piston arrangements 2 and 3 and 120 degrees of separation between cylinder piston arrangements 3 and 1.

In one embodiment, barrel cam 106 may be driven by motor 104. In one embodiment, barrel cam 106 may be driven by a source that is part of system 100. That is, the rotation of barrel cam 106 is generated by motor 104, which is part of system 100. In one embodiment, barrel cam 106 may be driven by a source that is part of system 100 but not a motor such as but not limited to an engine or an air motor. In one embodiment, barrel cam 106 may be driven by a source external to system 100.

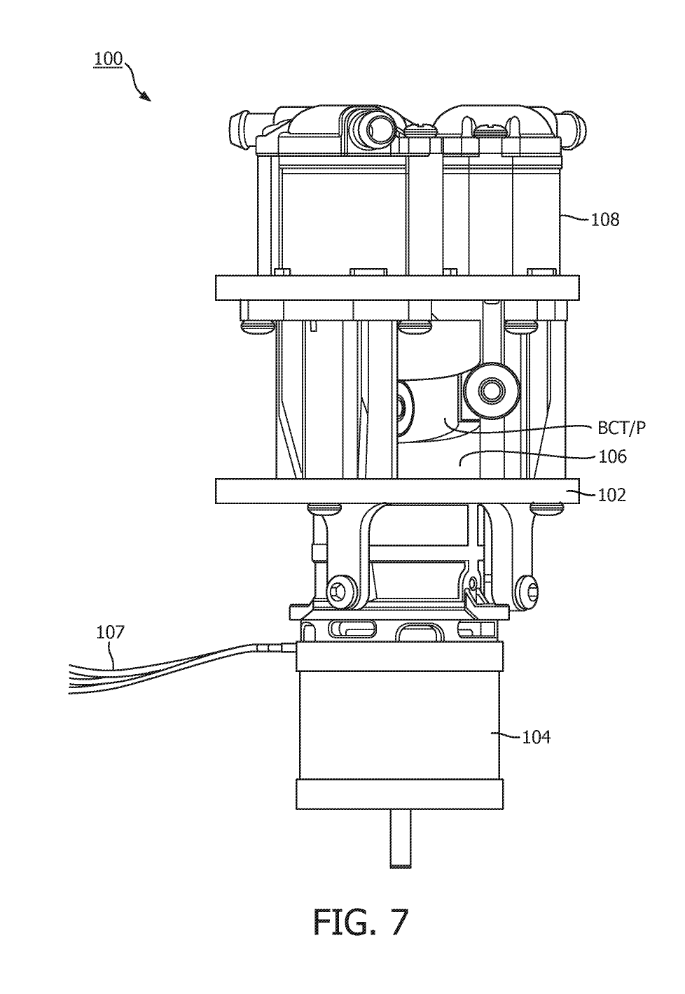

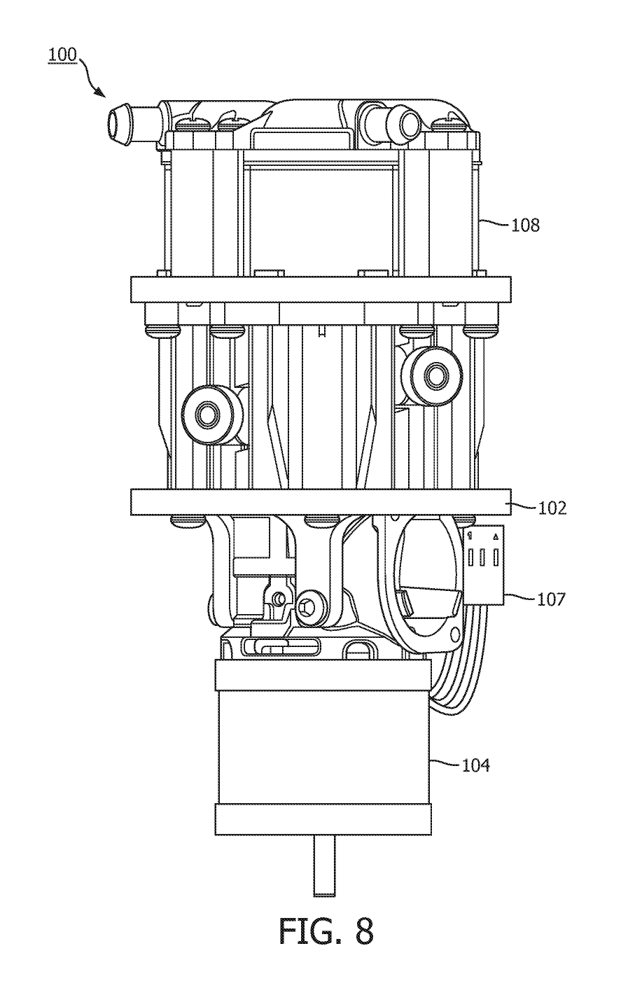

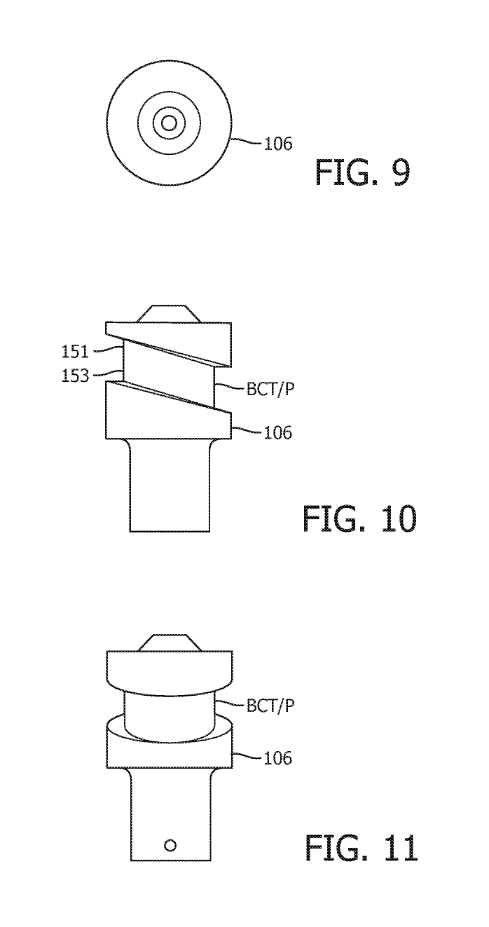

In one embodiment, cam 106 is a barrel or cylindrical cam. Referring to FIGS. 6 and 9-11, the term “barrel cam” as used herein is a generic term in referring to a cam/cylinder 151 in which follower 111 rides on the surface 153 of its cylinder 151. In one embodiment, the barrel cam/cylinder has a uniform cross section. In one embodiment, follower 111 is configured to interface, engage or mate with barrel cam 106 producing reciprocating motion of piston 116 as barrel cam 106 rotates.

In one embodiment, barrel cam 106 includes track BCT thereon. In one embodiment, track BCT includes a periodic track. In one embodiment, track BCT is a closed loop track. In one embodiment, track BCT includes a recessed track. In one embodiment, track BCT includes a groove. In one embodiment, track BCT is cut into the surface of cylinder/cam 106. In one embodiment, track BCT may be protruding from cylinder/cam 106. In one embodiment, barrel cam 106 and its track BCT are configured to convert rotational motion to linear motion parallel to the rotational axis of cylinder/cam 106. In one embodiment, cylinder/cam 106 may have several grooves/tracks cut into its surface and may drive several followers.

During rotation of cam 106, piston 116 is confined in its path of motion by cam track BCT by permitting piston 116 to travel freely in cam track BCT.

In illustrative embodiment, track BCT of barrel cam 106, when interfaced with piston 116 of cylinder piston arrangement 108, causes piston 116 to complete one full compression and intake stroke per rotation of barrel cam 106. In another embodiment, track BCT of barrel cam 106, when interfaced with piston 116 of cylinder piston arrangement 108, causes piston 116 to complete more than one compression and intake stroke per rotation of barrel cam 106. In one embodiment, system 100 may include more than one barrel cam 106 on a single rotating axis that interface with one or more different pistons.

Each piston 116 of cylinder piston arrangement 108 includes features that 1) interface with barrel cam 106 to facilitate reciprocating motion of piston 116 in its corresponding cylinder 110 as barrel cam 106 rotates; 2) interface with features 127 on compressor/pump housing/base 102 that limit the motion of piston 116 to linear reciprocation; and 3) interface with features 129 on the compressor/pump housing/base 102 that prevent rotation of piston 116.

In one embodiment, the features of piston 116 that interface with barrel cam 106 and its track BCT (i.e., to facilitate reciprocating motion of piston 116 in its corresponding cylinder 110 as barrel cam 106 rotates) include follower 111. In one embodiment, follower 111 may be integrally formed with piston 116. In another embodiment, follower 111 may be separately formed and operatively coupled/connected to piston 116 by any mechanism as would be appreciated by skilled in the art. In one embodiment, follower 111 may use bearings 155 to minimize friction. In one embodiment, follower 111 may have other shapes, sizes or configurations as would be appreciated by skilled in the art.

In one embodiment, the features of piston 116 that interface with the compressor/piston housing or base 102 to limit the reciprocating motion of piston 116 to be linear in nature include a follower 159 (e.g., linear guide follower). In one embodiment, linear guide follower 159 may be integrally formed with piston 116. In another embodiment, linear guide follower 159 may be separately formed and operatively coupled/connected to piston 116 by any mechanism as would be appreciated by skilled in the art. In one embodiment, linear guide follower 159 may use bearings 157 to minimize friction. In one embodiment, linear guide follower 159 may have other shapes, sizes or configurations as would be appreciated by skilled in the art.

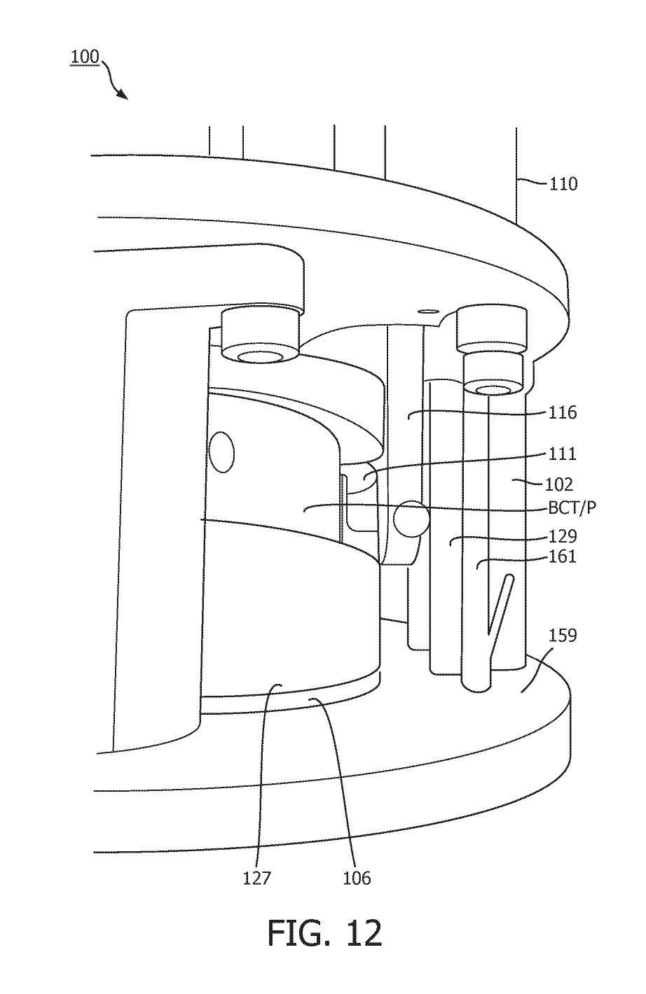

FIG. 12 also shows interengaging members 127, 159 to limit the movement of piston 116 to linear reciprocating motion (i.e., as piston 116 moves along the longitudinal axis L-L with respect to cylinder 110 and through the two ends 112, 114 of cylinder 110). That is, interengaging members 156, 158 are configured to engage, mate or interface with each other to the movement of piston 116 to linear reciprocating motion. In one embodiment, one 159 of interengaging members 127, 159 is disposed on piston 116 and the other 127 of interengaging members 127, 159 is disposed on base 102. As noted above, in one embodiment, interengaging member 127 is in the form of a track and interengaging member 159 is in the form of a follower in that track.

In one embodiment, other mechanisms, as would be appreciated by one skilled in the art, may be to limit the movement of piston 116 to linear reciprocating motion (i.e., as piston 116 moves along the longitudinal axis L-L with respect to cylinder 110 and through the two ends 112, 114 of cylinder 110).

In one embodiment, the feature of piston 116 that interfaces with the compressor/piston housing or base 102 to prevent rotation of piston 116 include a follower 161 (e.g., anti-rotation follower). In one embodiment, anti-rotation follower 161 may be integrally formed with piston 116. In another embodiment, linear guide follower 161 may be separately formed and operatively coupled/connected to piston 116 by any mechanism as would be appreciated by skilled in the art. In one embodiment, anti-rotation follower 161 may use bearings 163 to minimize friction. In one embodiment, anti-rotation follower 161 may have other shapes, sizes or configurations as would be appreciated by skilled in the art.

FIG. 12 shows interengaging members 129, 161 to limit the rotation of piston 116 as piston 116 moves along the longitudinal axis L-L with respect to cylinder 110 and through the two ends 112, 114 of cylinder 110. That is, interengaging members 129, 161 are configured to engage, mate or interface with each other to limit the rotation of piston 116 during its reciprocation. In one embodiment, one 161 of interengaging members 129, 161 is disposed on piston 116 and the other 129 of interengaging members 129, 161 is disposed on base 102. As noted above, in one embodiment, interengaging member 129 is in the form of a track/rail and interengaging member 161 is in the form of a follower in that track/rail.

In one embodiment, other mechanisms, as would be appreciated by one skilled in the art, may be used to limit the rotation of piston 116 as piston 116 moves along the longitudinal axis L-L with respect to cylinder 110 and through the two ends 112, 114 of cylinder 110.

In one embodiment, any or all of the features of piston 116 that interface with another feature of compressor/piston housing or base 102 may use bearings for minimizing friction. In one embodiment, bearings described above are optional.

In one embodiment, system 100 of the present patent application solves and improves upon many disadvantages of prior art eccentric driven reciprocating compressors.

For example, vibration exists in the prior art eccentric driven reciprocating pumps and compressors due to the nature of a mass that is located off the axis of rotation. To counter the off-center rotation of the eccentric, balance weights are generally added and/or portion of the eccentric are cut away to help balance the prior art rotating assembly.

In system 100 of the present patent application, the reciprocating motion is created through the use of barrel cam 106. In one embodiment, the design of barrel cam 106 is inherently more balanced than an eccentric (of the prior art eccentric driven reciprocating pump and compressor) due to the main mass of the barrel cam being uniform around the axis of rotation. This significantly reduces the vibration in system 100 of the present patent application.

Generally, in a reciprocating pump or compressor, there are two strokes—a compression stroke and an intake stroke. The compression stroke is the movement of the piston (or diaphragm) toward the top of the cylinder which reduces the volume within the cylinder causing the fluid to be pumped and/or compressed as it exits the cylinder. The intake stroke is the movement of the piston (or diaphragm) away from the top of the cylinder which increases the volume within the cylinder causing fluid to enter the cylinder.

In the prior art eccentric driven pump or compressor, the compression and intake strokes are identical in velocity and acceleration profile where each takes exactly one half of the rotation of the eccentric to complete. In a pump or compressor, the majority of the work of the system is done during the compression stroke and, in a system where the compression and intake strokes occur in the same period, there will be peaks of torque and power consumption during the compression stroke and less torque and power required during the intake stroke which can be inefficient due to the wasted energy in the intake stroke and taxing on the drive mechanism by the quick fluctuation on the torque being applied to the system.

In system 100 of the present patent application, profile of barrel cam 106 allows the compression and intake strokes each to have different velocity and acceleration profiles. That is, the velocity and acceleration profiles of system 100 are not inherently required to take exactly half the rotation of the barrel cam to complete.

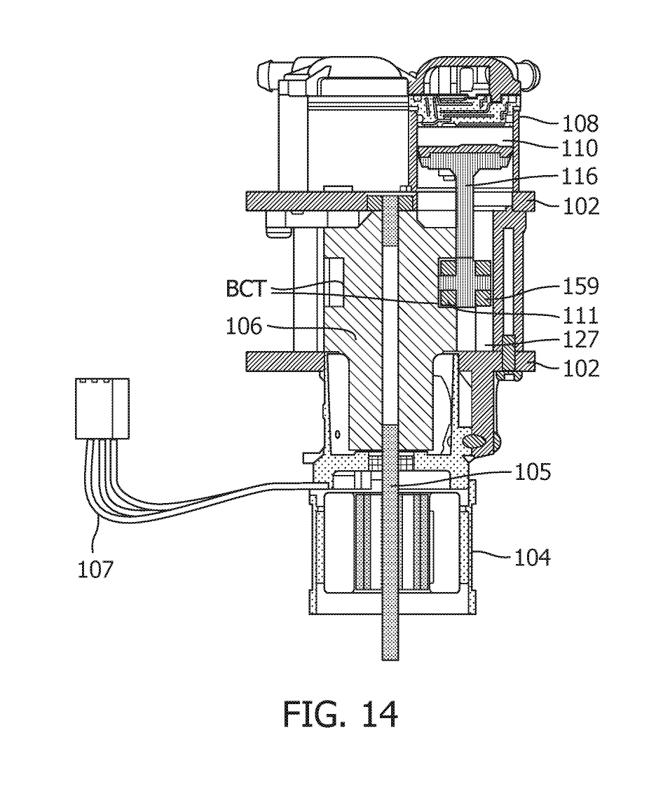

As illustrated in FIG. 16, a few examples of barrel cam stroke profiles are compared with an eccentric stroke profile, ESP. For example, stroke on the left hand side Y-axis of the graph and cam position (measured in degrees) is on the X-axis of the graph.

A few exemplary barrel cam stroke profiles of the present patent application may include hold top stroke profile, HTSP, ¾^{th} compression stoke and ¼^{th} intake stroke profile, 75C-251-SP, multi-stroke profile, MSP, multi-length stroke profile, MLSP, compression based stroke profile, CBSP, etc.

In one embodiment, profile 75C-251-SP of barrel cam 106 may be designed such that the compression stroke takes 75% of one full rotation of barrel cam 106 and the intake stroke takes the remaining 25% (of one full rotation of barrel cam 106). In one embodiment, profile of barrel cam 106 may be designed specifically such that the compression and intake strokes are optimized for the fluid, volume and pressure of the pump or compressor requirements. This may also include having more than one stroke per rotation of the cam and varying strokes through the rotation of the cam.

Thus, profile of barrel cam 106 of the present patent application is infinitely customizable and is not limited to the profiles described above. In one embodiment, profile of barrel cam 106 of the present patent application may also be optimized for a vacuum pump application where the intake stroke requires more power than the compression stroke.

Because the work being done by each stroke of the pump or compressor may be optimized for its application, in one embodiment, the barrel cam driven system of the present patent application consumes significantly less power than the equivalent prior art eccentric driven mechanism.

Below is a mathematical comparison of the power required to complete one cycle of the prior art eccentric driven compressor found in an oxygen concentrator to the 75%/25% barrel cam mechanism example described above. For example, the compressor of the oxygen concentrator operating at peak speed and peak pressure may have the following properties: piston diameter of 0.025 meters; stroke of 0.009 meters; peak pressure of 103,421 Pascal; speed of 1600 revolutions per minute (rpm) (26.7 revolutions per second (rps) or 1 rev/0.037s); compression force at peak pressure of 52 Newtown, and intake force of 2 Newton (estimate).

The compressor mechanism in this computation is simplified by assuming that the force is constant over the compression stroke and likewise in the intake stroke. Given that the compression stroke is of a higher force than the intake stroke and rotational velocity is constant, the following power requirements may be calculated:

$$Power = \frac{Work}{Time} = \frac{Force \cdot Displacement}{Time} ,$$

### 50%/50% Eccentric (Current SimplyGo Mini Compressor):

$${Time}_{intake} = {Time}_{comp} = 0.5 \cdot 0.037 s = 0.0185 s$$

$$\begin{matrix}Power = \frac{{Force}_{Comp} \cdot Displacement}{{Time}_{comp}} + \frac{{Force}_{intake} \cdot Displacement}{{Time}_{intake}} \\ = \frac{52 N \cdot 0.009 m}{0.0185 s} + \frac{2 N \cdot 0.009 m}{0.0185 s} \\ = 26.3 W\end{matrix}$$

### 75%/25% Barrel Cam:

$${Time}_{intake} = 0.25 \cdot 0.037 s = 0.0093 s$$

$${Time}_{comp} = 0.75 \cdot 0.037 s = 0.0277 s$$

$$\begin{matrix}Power = \frac{{Force}_{Comp} \cdot Displacement}{{Time}_{comp}} + \frac{{Force}_{intake} \cdot Displacement}{{Time}_{intake}} \\ = \frac{52 N \cdot 0.009 m}{0.0277 s} + \frac{2 N \cdot 0.009 m}{0.0093 s} \\ = 22.6 W\end{matrix}$$

As shown above, the prior art 50%/50% compressor required a power of 26.3 Watt to operate whereas 75%/25% barrel cam mechanism of the present patent application required a power of 22.6 Watt to operate. In this simplified example of the compressor of the oxygen concentrator, using the 75%/25% barrel cam mechanism yields a 14% lower power consumption. However, minimizing power using the equation above yields an optimized compression stroke time of 0.031 seconds and an intake stroke time of 0.006 seconds (84%/16%) which evaluates to a power requirement of 18.1 Watts, or 31% lower power than the equivalent prior art eccentric driven example.

The prior art eccentric type pump or compressor requires that the axis of reciprocation be perpendicular to the axis of rotation in order to convert the rotational motion of the eccentric to a reciprocating motion. The barrel cam driven pump or compressor of the present patent application, however, has the axis of reciprocation parallel to the axis of rotation because the track of the barrel cam converts the rotational motion to a reciprocating motion.

In the prior art eccentric driven pump or compressor, the eccentrics of multiple cylinders must align in one continuous line which means that multiple cylinders can only be a close together as the cylinders allow them to be in a line, much like an inline automotive engine. There are more efficient ways of aligning cylinders together by using multiple planes of banks of cylinders. For example, two, four, six, eight, ten and twelve cylinders are commonly aligned in a V pattern in automotive engines. While this decreases the overall length of the arrangement of cylinders, it adds to the width of the arrangement. Older airplane engines often used a radial type alignment where the cylinders were aligned in a circular pattern around one central eccentric. While this arrangement again reduces the overall length of the arrangement of the cylinders, it significantly increases the width and depth of the cylinder arrangement due to the cylinders needing to be perpendicular to the axis of rotation.

The barrel cam pump or compressor of the present patent application uses a radial type pattern similar to the older airplane engines, however, because the axis of reciprocation is parallel instead of perpendicular to the axis of rotation, the cylinders more closely stack in a circular pattern and take up only the length of one cylinder. This arrangement yields significantly less growth in overall volume as cylinders are added compared to a prior art eccentric pump or compressor.

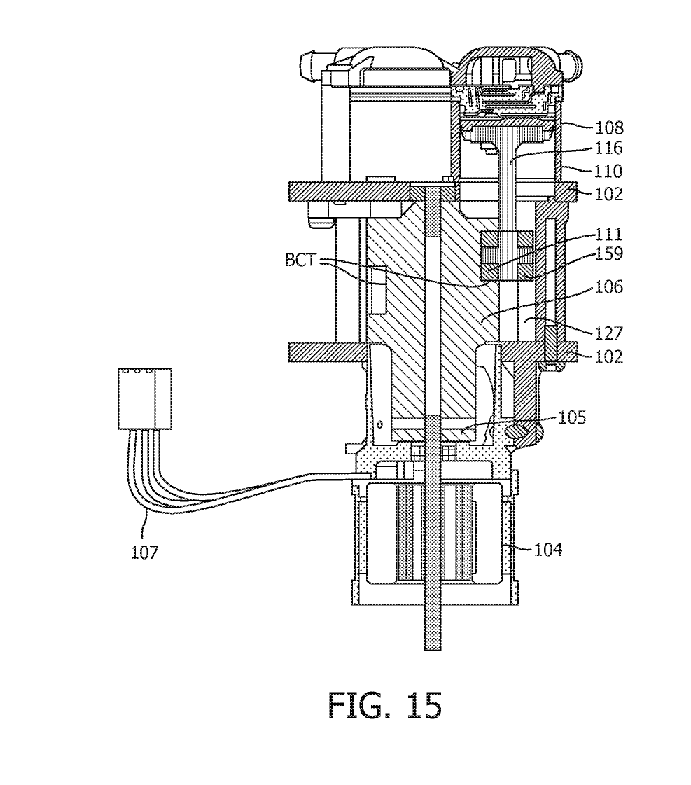

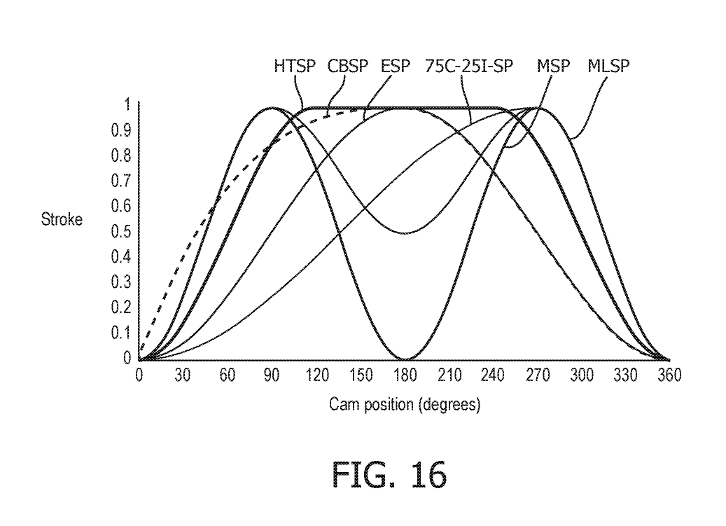

The prior art compressor (e.g., used in an oxygen concentrator), shown in FIG. 17, is used as an example and compared to a prior art radial type compressor, shown in FIG. 18, and the barrel cam type compressor of the present patent application, shown in FIG. 19. In one embodiment, same cylinder sizes, same stroke(s), and same motor(s) are used when comparing the prior art compressor in FIG. 17 with the prior art radial type compressor of FIG. 18 and with the barrel cam type compressor of the present patent application of FIG. 19. For example, comparing FIGS. 17-19, the barrel cam compressor of the present patent application in FIG. 19 uses about 30% less volume with the same two cylinders, stroke and motor as the prior art compressor in FIG. 17 of the oxygen concentrator.

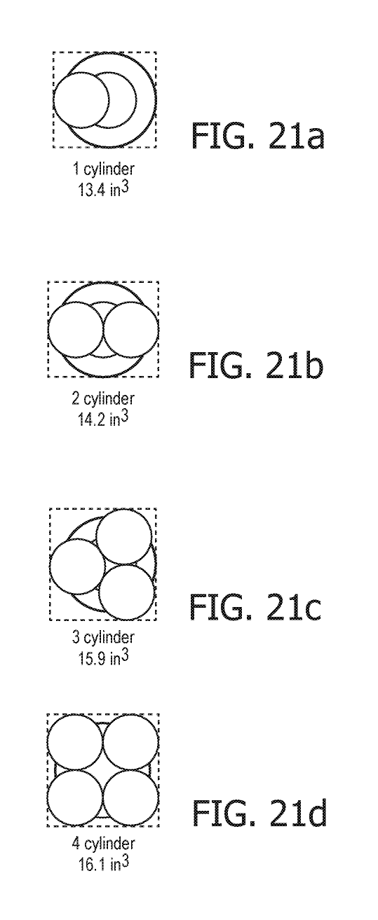

FIG. 22 shows a graphical illustration depicting a comparison of occupied volume by cylinder count between a prior art eccentric driven pump/compressor EDP/C and system 100 for pumping and/or compressing fluids in accordance with an embodiment of the present patent application. For example, occupied volume (in cubic inch) on the left hand side Y-axis of the graph and cylinder count (i.e., number of cylinders in the compressor/pump) is on the X-axis of the graph.

Comparing the change in occupied volume as cylinder count increases using the prior art compressor (e.g., used in an oxygen concentrator) EDP/C and an equivalent barrel cam compressor BCP/C of the present patent application, it becomes clear that occupied volume increases at a significantly slower pace with the barrel cam compressor BCP/C of the present patent application than it does with the prior art compressor EDP/C.

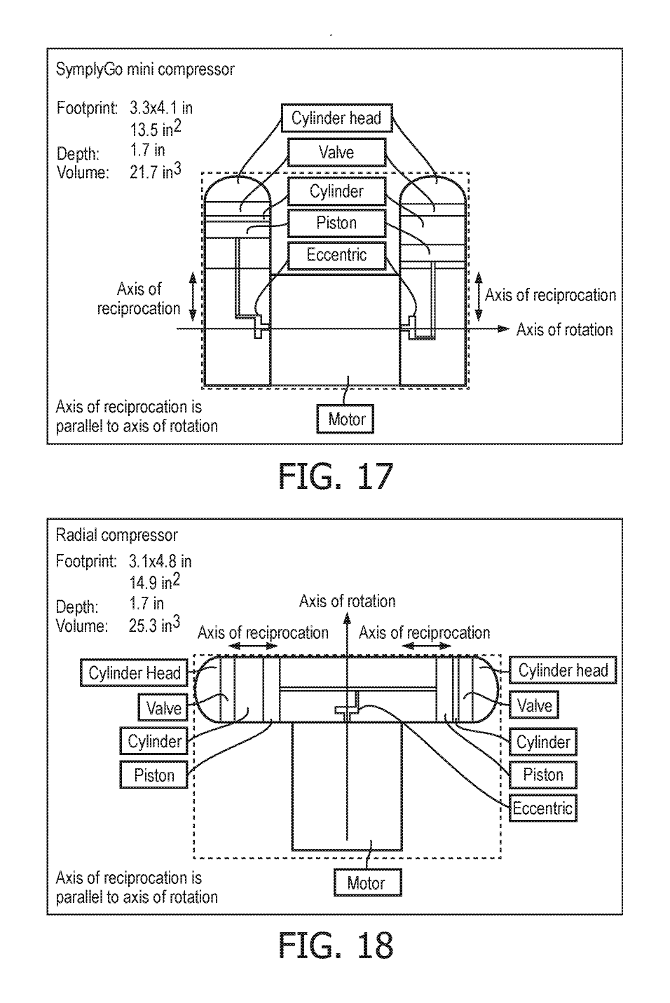

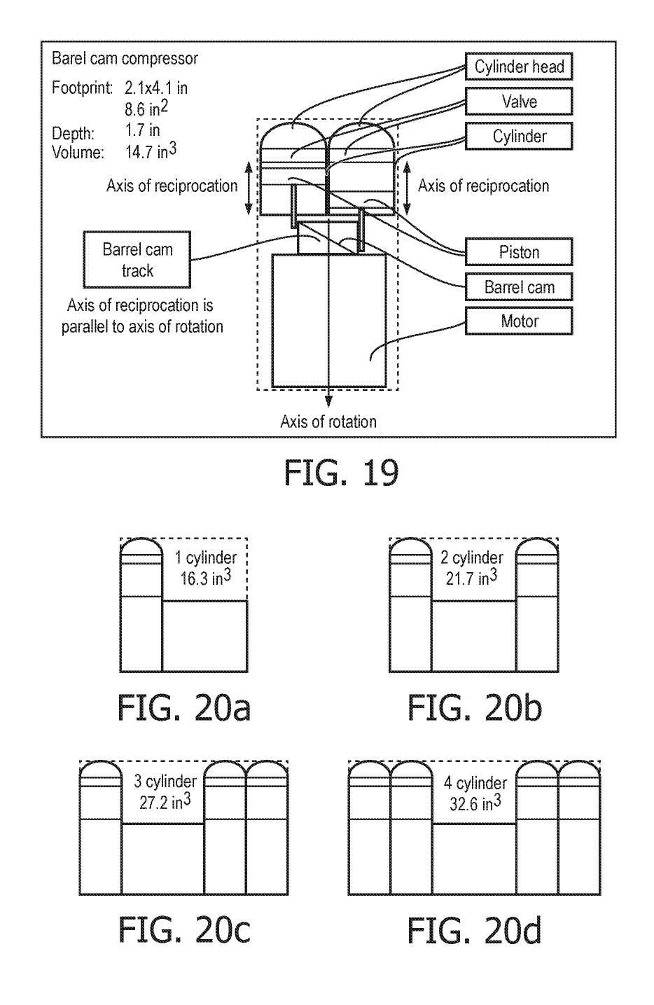

Table below provides a comparison of occupied volume of the prior art compressor EDP/C and the barrel cam compressor BCP/C of the present patent application for a single cylinder, two cylinder, three cylinder, and four cylinder arrangements. In every case shown below and as shown in FIGS. 20a-20d and 21a-21d, the barrel cam compressor BCP/C of the present patent application occupies lesser volume than the equivalent prior art eccentric compressor EDP/C. It is assumed that the overall assembly depth is constant at 1.7 inches for the prior art eccentric compressor. It is assumed that the overall assembly height is constant at 4.1 inches for the barrel cam compressor of the present patent application.

| | Occupied Volume | Occupied Volume |
|---|---|---|
| | (in cubic in) | (in cubic in) of barrel |
| Number of | of the prior art | cam compressor of the |
| Cylinders | eccentric compressor | present patent application |
| 1 cylinder | 16.3 | 13.4 |
| 2 cylinders | 21.7 | 14.2 |
| 3 cylinders | 27.2 | 15.9 |
| 4 cylinders | 32.6 | 16.1 |

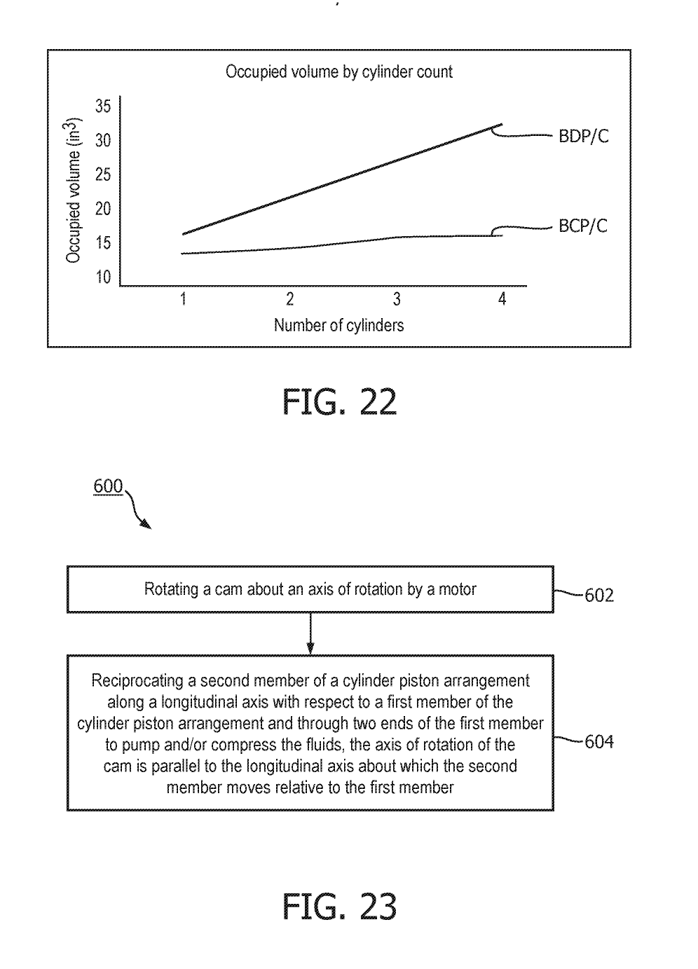

FIG. 23 illustrates an exemplary method 600 for pumping and/or compressing fluids using motor 104 and one or more cylinder piston arrangements 108. Each cylinder piston arrangement 108 includes first member 110 and second member 116. First member 110 has longitudinal axis L-L and two ends 112, 114 and is fixedly attached to base 102. Second member 116 is configured to be operatively coupled to cam 106. The procedures of method 600 presented herein are intended to be illustrative. In one embodiment, method 600 may be accomplished with one or more additional procedures not described, and/or without one or more of the procedures discussed. Additionally, the order in which the procedures of method 600 is illustrated in FIG. 23 and described herein is not intended to be limiting.

At a procedure 602 of method 600, cam 106 is rotated about axis of rotation R-R by motor 104. At a procedure 604 of method 600, second member 116 is reciprocated along longitudinal axis L-L with respect to first member 110 and through two ends 112, 114 of first member 110 to pump and/or compress the fluids.

In one embodiment, system 100 of the present patent application may be used in oxygen concentrators configured for compressing ambient air for the pressure swing absorption cycle. System 100 of the present patent application is used for this application due to its ability to customize and optimize the compression and intake strokes, to improve battery life, to minimize vibration, to minimize noise and to make the overall compressor size smaller and therefore the oxygen concentrator smaller. In one embodiment, system 100 is configured to scale up or down as needed. In one embodiment, system 100 is configured to scale up or down both in size and in the number of cylinders to fit the applications where the benefits would be the same as with the oxygen concentrators: less power consumption, less vibration, less noise, and smaller compressor size.

In one embodiment, system 100 of the present patent application may be used in medical devices, such as but not limited to oxygen concentrators, CPAP and BiPAP sleep apnea products, Hospital Respiratory Ventilation products, Breast Pumps, Patient Monitoring (blood pressure, etc.) devices, and/or other medical devices that require compressed or pumped fluids. System 100 of the present patent application may also be used in consumer products such as coffee, cooking and food preparation, and/or any other consumer products that require compressed or pumped fluids.

In one embodiment, system 100 of the present patent application may also be used in automotive, transportation, chemical manufacturing, food and beverage service and manufacturing, construction, agriculture, fuel industry, healthcare, military, mining, household, consumer goods, landscaping, water treatment, waste management, etc. to name a few possibilities where the application for efficient, compact pumps, vacuum pumps and compressors exists.

In one embodiment, any dimension described in the present patent application, is up to 5 percent greater than or up to 5 percent less than those described above. In one embodiment, any dimension described in the present patent application, is up to 10 percent greater than or up to 10 percent less than those described above. In one embodiment, any dimension described in the present patent application, is up to 20 percent greater than or up to 20 percent less than those described above. In one embodiment, all the dimensions shown in FIGS. 17-19, 20a-20d and 21a-21d are in inches.

In one embodiment, system 100 may comprise one or more computing devices that are programmed to perform the functions described herein. For example, system 100 may comprise one or more physical processors programmed with computer program instructions which, when executed cause computer system and/or one or more physical processors to perform the functions described herein. The computing devices may include one or more electronic storages (e.g., database, or other electronic storages), one or more physical processors programmed with one or more computer program instructions, and/or other components. The computing devices may include communication lines or ports to enable the exchange of information with a network (e.g., network) or other computing platforms via wired or wireless techniques (e.g., Ethernet, fiber optics, coaxial cable, WiFi, Bluetooth, near field communication, or other communication technologies). The computing devices may include a plurality of hardware, software, and/or firmware components operating together to provide the functionality attributed herein to the servers. For example, the computing devices may be implemented by a cloud of computing platforms operating together as the computing devices.

The electronic storages may comprise non-transitory storage media that electronically stores information. The electronic storage media of the electronic storages may include one or both of system storage that is provided integrally (e.g., substantially non-removable) with the servers or removable storage that is removably connectable to the servers via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information received from the servers, information received from client computing platforms, or other information that enables the servers to function as described herein.

The processors may be programmed to provide information processing capabilities in system 100. As such, the processors may include one or more of a digital processor, an analog processor, or a digital circuit designed to process information, an analog circuit designed to process information, a state machine, and/or other mechanisms for electronically processing information. In one embodiment, the processors may include a plurality of processing units. These processing units may be physically located within the same device, or the processors may represent processing functionality of a plurality of devices operating in coordination. The processors may be programmed to execute computer program instructions to perform functions described herein or other subsystems. The processors may be programmed to execute computer program instructions by software; hardware; firmware; some combination of software, hardware, or firmware; and/or other mechanisms for configuring processing capabilities on the processors.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the present patent application has been described in detail for the purpose of illustration based on what is currently considered to be the most practical and preferred embodiments, it is to be understood that such detail is solely for that purpose and that the present patent application is not limited to the disclosed embodiments, but, on the contrary, is intended to cover modifications and equivalent arrangements that are within the spirit and scope of the appended claims. For example, it is to be understood that the present patent application contemplates that, to the extent possible, one or more features of any embodiment can be combined with one or more features of any other embodiment.

What is claimed is:

1. A system for pumping and/or compressing fluids, the system comprising:
a base;
a motor;
a cam configured to be rotated about an axis of rotation (R-R) by the motor; and
one or more cylinder piston arrangements, each cylinder piston arrangement comprising:
a first member having a longitudinal axis (L-L) and two ends, the first member being fixedly attached to the base; and
a second member configured to be operatively coupled to the cam and to be movable along the longitudinal axis with respect to the first member and through the two ends of the first member, wherein the axis of rotation of the cam is parallel to the longitudinal axis about which the second member moves relative to the first member.

2. The system of claim 1, wherein the first member is a cylinder, the second member is a piston, and the cam is a barrel cam, and wherein the barrel cam has a track (BCT) that, when interfaced with the piston, causes the piston to complete at least one full compression stroke and intake stroke per a rotation of the barrel cam.

3. The system of claim 1, wherein the second member of each cylinder piston arrangement is configured to reciprocate through a following mechanism that interfaces with a track (BCT) of the cam and to reciprocate in a motion parallel to the axis of rotation.

4. The system of claim 1, wherein each cylinder piston arrangement further includes interengaging members that are configured to limit the movement of the second member to a linear reciprocating motion as the second member moves along the longitudinal axis with respect to the corresponding first member and through two ends of the corresponding first member.

5. The system of claim 1, wherein each cylinder piston arrangement further includes interengaging members that are configured to limit the rotation of the second member as the second member moves along the longitudinal axis with respect to the corresponding first member and through two ends of the corresponding first member.

6. A method for pumping and/or compressing fluids using a motor and one or more cylinder piston arrangements, each cylinder piston arrangement comprising a first member and a second member, the first member having a longitudinal axis (L-L) and two ends and being fixedly attached to a base, the second member being configured to be operatively coupled to a cam, the method comprising:
rotating the cam about an axis of rotation (R-R) by the motor; and
reciprocating the second member of each cylinder piston arrangement along the longitudinal axis with respect to the corresponding first member and through the two ends of the corresponding first member to pump and/or compress the fluids, wherein the axis of rotation of the cam is parallel to the longitudinal axis about which the second member moves relative to the corresponding first member.

7. The method of claim 6, wherein the first member is a cylinder, the second member is a piston, and the cam is a barrel cam, and wherein the barrel cam has a track (BCT) that, when interfaced with the piston, causes the piston to complete at least one full compression stroke and intake stroke per a rotation of the barrel cam.

8. The method of claim 6, wherein the second member is reciprocated through a following mechanism that interfaces with a track (BCT) of the cam and wherein the second member is reciprocated in a motion parallel to the axis of rotation.

9. The method of claim 6, further comprising limiting the reciprocating movement of the second member to a linear reciprocating motion as the second member reciprocates along the longitudinal axis with respect to the corresponding first member and through two ends of the corresponding first member.

10. The method of claim 6, further comprising limiting the rotation of the second member as the second member reciprocates along the longitudinal axis with respect to the corresponding first member and through two ends of the corresponding first member.

11. A system for pumping and/or compressing fluids using a motor and one or more cylinder piston arrangements, each cylinder piston arrangement comprising a first member and a second member, the first member having a longitudinal axis (L-L) and two ends and being fixedly attached to a base, the system comprising:
means for operatively coupling the second member to the motor, the means being rotated about an axis of rotation (R-R) by the motor and the means being configured for reciprocating the second member of each cylinder piston arrangement along the longitudinal axis with respect to the corresponding first member and through the two ends of the corresponding first member to pump and/or compress the fluids,
wherein the axis of rotation of the means is parallel to the longitudinal axis about which the second member moves relative to the corresponding first member.

12. The system of claim 11, wherein the first member is a cylinder, the second member is a piston, and the means is a barrel cam, and wherein the barrel cam has a track (BCT) that, when interfaced with the piston, causes the piston to complete at least one full compression stroke and intake stroke per a rotation of the barrel cam.

13. The system of claim 11, wherein the second member is reciprocated through a following mechanism that interfaces with a track (BCT) of the means and wherein the second member is reciprocated in a motion parallel to the axis of rotation.

14. The system of claim 11, further comprising a means for limiting the reciprocating movement of the second member to a linear reciprocating motion as the second member reciprocates along the longitudinal axis with respect to the corresponding first member and through two ends of the corresponding first member.

15. The system of claim 11, further comprising a means for limiting the rotation of the second member as the second member reciprocates along the longitudinal axis with respect to the corresponding first member and through two ends of the corresponding first member.
